(19) United States
(12) Patent Application Publication
(10) Pub. No.: US 2021/0100261 A1
(43) Pub. Date: Apr. 8, 2021

(54) COMPOSITION FOR HEALTH BENEFIT AND DETOXIFICATION

(71) Applicant: Robert Torres, SR., Hammonton, NJ (US)

(72) Inventor: Robert Torres, SR., Hammonton, NJ (US)

(21) Appl. No.: 17/125,805

(22) Filed: Dec. 17, 2020

Related U.S. Application Data
(60) Provisional application No. 62/949,084, filed on Dec. 17, 2019.

(51) Int. Cl. A23F 3/18

(52) U.S. Cl. CPC A23F 3/18

(57) ABSTRACT

Disclosed is a beverage composition that includes tea leaves, organic roasted dandelion root, organic cocoa shell, organic cardamom seed, organic ginger root, organic clove bud, organic black pepper, organic Ceylon cinnamon, peppermint, chicory root, orange peel, Manuka honey, lemon concentrate, and branch chain amino acids.

### CROSS-REFERENCE TO RELATED APPLICATIONS

This application claims priority to the U.S. provisional patent application Ser. No. 62/949,084 filed on Dec. 17, 2019, which is incorporated herein by reference in its entirety.

### FIELD OF INVENTION

The present invention relates to a composition, and more particularly, the present invention relates to a composition for health benefits and detoxification.

### BACKGROUND

People have been enjoying tea for centuries. It is a popular beverage among masses and naturally rich in antioxidants. Tea is consumed for instant warm up the body but is also known to have a long list of health benefits. Tea hydrates the body, enhances immunities, and known to protect against cancers and like diseases. Tea is also used for reducing the body weight.

It is always desirable to enhance the nutritional value of the food products. Thus, a need is appreciated for a teat composition having improved health benefits.

### SUMMARY OF THE INVENTION

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The principal object of the present invention is therefore directed to an improved tea composition having enhanced health benefits.

It is another object of the present invention that the composition provides detoxification of the human body.

It is still another object of the present invention that the composition is economical to produce.

In one aspect, disclosed is a composition comprising tea leaves, organic roasted dandelion root, organic cocoa shell, organic cardamom seed, organic ginger root, organic clove bud, organic black pepper, organic Ceylon cinnamon, peppermint, chicory root, orange peel, Manuka honey, lemon concentrate, and branch chain amino acids.

In one aspect, disclosed is a beverage produced by boiling a composition comprising tea leaves, organic roasted dandelion root, organic cocoa shell, organic cardamom seed, organic ginger root, organic clove bud, organic black pepper, organic Ceylon cinnamon, peppermint, chicory root, orange peel, Manuka honey, lemon concentrate, and branch chain amino acids in water.

In one aspect, the above disclosed composition is boiled at 212° F. for 5 min.

These and other objects and advantages of the embodiments herein will become readily apparent from the following detailed description taken in conjunction with the accompanying drawings.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods and compositions. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Unless otherwise indicated, all numbers expressing quantities of ingredients used in this disclosure are to be understood as being modified in all instances by the term “about”. Accordingly, unless indicated to the contrary, the numerical parameters set forth in this disclosure are approximations that may vary depending upon the desired properties sought to be obtained by the present disclosure. At the very least, and not as an attempt to limit the application of the doctrine of equivalents to the scope of any claims, each numerical parameter should be construed in light of the number of significant digits and ordinary rounding approaches.

Disclosed is a beverage composition that improves the quality of life, improves the health of the body, enhances liver and kidney function, lowers blood sugar, kills harmful bacteria including H. pylori bacteria in the stomach, repairs torn muscle fibers due to a physical activity, improves circulation, and provides an overall wellness of human beings. The disclosed beverage composition can provide for detoxification of the human body.

In one exemplary embodiment the disclosed composition includes tea leaves, organic roasted dandelion root, organic cocoa shell, organic cardamom seed, organic ginger root, organic clove bud, organic black pepper, organic Ceylon cinnamon, peppermint, chicory root, orange peel, Manuka honey, lemon concentrate, and branch chain amino acids. Optionally, the composition may also include Cellfood by NuScience.

In one embodiment, disclosed is a beverage prepared by boiling a composition including tea leaves, organic roasted dandelion root, organic cocoa shell, organic cardamom seed, organic ginger root, organic clove bud, organic black pepper, organic Ceylon cinnamon, peppermint, chicory root, orange peel, Manuka honey, lemon concentrate, and branch chain amino acids in water. The composition can be boiled at 212° F. for about 5-10 minutes. Optionally, the composition may also include Cellfood by NuScience.

In one aspect, the tea leaves can be Green tea, Black tea, Herbal tea, Oolong tea, White tea, Fermented tea, or Yellow tea.

In one aspect, the organic roasted dandelion root, organic cocoa shell, organic cardamom seed, organic ginger root, organic clove bud, organic black pepper, organic Ceylon cinnamon, chicory root, and orange peel are present in powder form.

In one aspect, the organic roasted dandelion root, organic cocoa shell, organic cardamom seed, organic ginger root, organic clove bud, organic black pepper, organic Ceylon cinnamon, chicory root, and orange peel are present in concentrate form.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A beverage composition comprising:
tea leaves, organic roasted dandelion root, organic cocoa shell, organic cardamom seed, organic ginger root, organic clove bud, organic black pepper, organic Ceylon cinnamon, peppermint, chicory root, orange peel, Manuka honey, lemon concentrate, and branch chain amino acids.

2. The beverage composition according to claim 1, wherein the tea leaves are selected from a group consisting of green tea, black tea, herbal tea, Oolong tea, white tea, fermented tea, yellow tea, or a combination thereof.

3. The beverage composition according to claim 1, wherein the organic roasted dandelion root, organic cocoa shell, organic cardamom seed, organic ginger root, organic clove bud, organic black pepper, organic Ceylon cinnamon, chicory root, and the orange peel are present in powder form.

4. The beverage composition according to claim 1, wherein the organic roasted dandelion root, organic cocoa shell, organic cardamom seed, organic ginger root, organic clove bud, organic black pepper, organic Ceylon cinnamon, chicory root, and the orange peel are present in concentrate form.

5. A beverage prepared by boiling a composition in water, the composition comprising tea leaves, organic roasted dandelion root, organic cocoa shell, organic cardamom seed, organic ginger root, organic clove bud, organic black pepper, organic Ceylon cinnamon, peppermint, chicory root, orange peel, Manuka honey, lemon concentrate, and branch chain amino acids.

6. The beverage according to claim 5, wherein the composition is boiled at 212° F. for 5-10 minutes.
